(19) United States
(12) Patent Application Publication
(10) Pub. No.: US 2017/0095801 A1
(43) Pub. Date: Apr. 6, 2017

(54) Thermally Stable Zero-PGM Three Way Catalyst with High Oxygen Storage Capacity

(71) Applicant: Clean Diesel Technologies, Inc., Oxnard, CA (US)

(72) Inventors: Zahra Nazarpoor, Camarillo, CA (US); Stephen J. Golden, Santa Barbara, CA (US)

(73) Assignee: CLEAN DIESEL TECHNOLOGIES, INC., Oxnard, CA (US)

(21) Appl. No.: 14/872,571

(22) Filed: Oct. 1, 2015

(51) Int. Cl. B01J 23/889; B01J 37/04; B01J 37/02; B01J 23/00; B01J 37/08

(52) U.S. Cl. CPC B01J 23/8892; B01J 23/005; B01J 37/08; B01J 37/0242; B01J 37/04

(57) ABSTRACT

The present disclosure describes ZPGM catalyst material compositions having significantly high oxygen storage capacity for a plurality of TWC applications. The disclosed ZPGM catalyst material compositions include a Cu—Mn spinel deposited on doped Zirconia support oxide. The disclosed ZPGM catalyst material compositions exhibit significant high OSC stability properties after fuel cut aging. The improved thermal stability and OSC properties of the disclosed ZPGM catalyst material compositions are determined by performing a standard isothermal oscillating OSC tests. Fresh and aged ZPGM catalyst material compositions are employed within the standard isothermal oscillating OSC test, over multiple reducing/oxidizing cycles at a temperature of about 575° C.

### BACKGROUND

Field of the Disclosure

This disclosure relates generally to catalyst materials, and more particularly, to catalyst material compositions having high oxygen storage capacity utilized within three-way catalysts (TWC) systems.

Background Information

Catalysts within catalytic converters have been used to decrease the pollution associated with exhaust from various sources, such as, automobiles, boats, and other engine-equipped machines. Significant pollutants contained within the exhaust gas of gasoline engines include carbon monoxide (CO), unburned hydrocarbons (HC), and nitrogen oxides (NOₓ), among others.

Conventional gasoline exhaust systems employ three-way catalysts (TWC) technology and are referred to as three way catalyst (TWC) systems. TWC systems convert the CO, HC and NOₓ into less harmful pollutants. Typically, TWC systems include a substrate structure upon which promoting oxides are deposited. Bimetallic catalysts, based on platinum group metals (PGM), are then deposited upon the promoting oxides. PGM materials include Pt, Rh, Pd, Ir, or combinations thereof. Some conventional TWC systems have been developed to incorporate an oxygen storage material (OSM) that stores oxygen during the leaner periods of the engine operating cycle and then releases the stored oxygen during the richer periods of the engine operating cycle. These TWC systems exhibit more efficient conversion of the CO, HC and NOₓ within the exhaust gases into less harmful pollutants.

Although PGM catalyst materials are effective for toxic emission control and have been commercialized by the emissions control industry, PGM materials are scarce and expensive. This high cost remains a critical factor for wide spread applications of these catalyst materials. Therefore, there is a need to provide a lower cost TWC system exhibiting catalytic properties substantially similar to or better than the catalytic properties exhibited by TWC systems employing PGM catalyst materials.

### SUMMARY

The present disclosure describes Zero-PGM (ZPGM) catalyst material compositions with enhanced oxygen storage capacity (OSC) for improved performance of three-way catalyst (TWC) systems. Further, the present disclosure describes ZPGM catalyst material compositions having significantly high OSC stability properties after fuel cut aging, thereby making catalyst manufacturing independent of using PGM and rare earth metal oxides as oxygen storage materials (OSM) for TWC applications.

According to some embodiments, the ZPGM catalyst compositions are produced according to a catalyst configuration including a suitable substrate, a washcoat (WC) layer, an overcoat (OC) layer, and an impregnation (IMP) layer. In these embodiments, the layers within the catalyst configuration are produced by employing any of the conventional synthesis methods.

In some embodiments, the disclosed ZPGM catalyst compositions are configured to include a WC layer of Alumina, coated onto a suitable substrate. In these embodiments, the OC layer includes a plurality of support oxides, such as, MgAl₂O₄, Al₂O₃—BaO, Al₂O₃—La₂O₃, ZrO₂—CeO₂—Nd₂O₃—Y₂O₃, CeO₂—ZrO₂, CeO₂, SiO₂, Alumina silicate, ZrO₂—Y₂O₃—SiO₂, Al₂O₃—CeO₂, Al₂O₃—SrO, TiO₂-10% ZrO₂, TiO₂-10% Nb₂O₅, SnO₂—TiO₂, ZrO₂—SnO₂—TiO₂, BaZrO₃, BaTiO₃, BaCeO₃, ZrO₂—Pr₆O₁₁, ZrO₂—Y₂O₃, ZrO₂—Nb₂O₅, Al—Zr—Nb, and Al—Zr—La, amongst others. Further to these embodiments, the OC layer includes Pr-doped Zirconia (ZrO₂-10%Pr₆O₁₁) support oxide.

In some embodiments, the IMP layer within the ZPGM catalyst compositions is produced including a plurality of binary spinel structures. In these embodiments, exemplary binary spinel structures include aluminum, magnesium, manganese, gallium, nickel, copper, silver, cobalt, iron, chromium, titanium, tin, or mixtures thereof. Further to these embodiments, the IMP layer includes a Cu₁Mn₂O₄ binary spinel structure. In these embodiments, the IMP layer of Cu₁Mn₂O₄ spinel structure is coated onto the OC layer of doped Zirconia support oxide by an impregnation method to form the ZPGM catalyst.

In other embodiments, the disclosed ZPGM catalyst compositions are subjected to a standard isothermal oscillating OSC test, to assess/verify O₂ and CO delay times. In these embodiments, different O₂ and CO delay times under rich and lean conditions are obtained by selecting a range of time on stream times to characterize the OSC stability properties of fresh and aged ZPGM catalyst composition samples.

In some embodiments, the disclosed ZPGM catalyst compositions are subjected to a standard isothermal oscillating OSC test to assess/verify the OSC stability of aged ZPGM catalyst composition samples. In these embodiments, the oscillating OSC test measures a plurality of O₂ and CO delay times under rich and lean conditions of the ZPGM catalyst material compositions.

In some embodiments, after the aging process the disclosed ZPGM catalyst compositions exhibits significantly higher catalytic activity and OSC stability. In these embodiments, the enhanced level of OSC stability properties can be attributed to the Cu—Mn spinel coated onto the OC layer of the doped Zirconia support oxide. Further to these embodiments, the disclosed ZPGM catalyst compositions represent an advantage for a new generation of ZPGM catalyst materials due to the lower catalyst cost of the disclosed ZPGM catalyst compositions and the associated impact of said lower catalyst cost. In these embodiments, disclosed ZPGM catalyst compositions demonstrate substantially similar or improved catalytic performance to conventional TWC systems while allow for the aforementioned reduction in catalyst costs.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 is a graphical representation illustrating an improved three-way catalyst (TWC) system configuration, including a washcoat layer coated onto a suitable substrate, an impregnation layer coated onto an overcoat layer, according to an embodiment.

FIG. 2 is a graphical representation illustrating isothermal oscillating OSC test results of O₂ and CO delay times, at about 575° C., according to an embodiment.

FIG. 3 is a graphical representation illustrating isothermal oscillating OSC stability test results of fresh ZPGM catalyst composition samples including test results of O2 and CO delay times at about 575° C., according to an embodiment.

FIG. 4 is a graphical representation illustrating isothermal oscillating OSC test results of CO conversion stability on fresh ZPGM catalyst composition samples, at about 575° C., according to an embodiment.

FIG. 5 is a graphical representation illustrating isothermal oscillating OSC test results of OSC stability of aged ZPGM catalyst composition samples, at about 575° C., according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms have the following definitions:

“Substrate” refers to any material of any shape or configuration that yields a sufficient surface area for depositing a washcoat and/or overcoat.

“Washcoat” refers to at least one coating including at least one oxide solid that may be deposited on a substrate.

“Overcoat” refers to at least one coating that may be deposited on at least one washcoat or impregnation layer.

“Support oxide” refers to porous solid oxides, typically mixed metal oxides, which are used to provide a high surface area which aids in oxygen distribution and exposure of catalysts to reactants such as NOₓ, CO, and hydrocarbons.

“Catalyst” refers to one or more materials that may be of use in the conversion of one or more other materials.

“Catalyst system” refers to any system including a catalyst, such as a PGM catalyst, or a

ZPGM catalyst a system, of at least two layers including at least one substrate, a washcoat, and/or an overcoat.

“Platinum group metals (PGM)” refers to platinum, palladium, ruthenium, iridium, osmium, and rhodium.

“Zero-PGM (ZPGM) catalyst” refers to a catalyst completely or substantially free of platinum group metals (PGM).

“Three-Way Catalyst” refers to a catalyst able of performing the three simultaneous tasks of reduction of nitrogen oxides to nitrogen and oxygen, oxidation of carbon monoxide to carbon dioxide, and oxidation of unburnt hydrocarbons to carbon dioxide and water.

“Spinel” refers to any minerals of the general formulation AB₂O₄ where the A ion and B ion are each selected from mineral oxides, such as, magnesium, iron, zinc, manganese, aluminum, chromium, or copper, amongst others.

“Milling” refers to the operation of breaking a solid material into a desired grain or particle size.

“Impregnation” refers to the process of totally saturating a solid layer with a liquid compound.

“Calcination” refers to a thermal treatment process applied to solid materials, in presence of air, to bring about a thermal decomposition, phase transition, or removal of a volatile fraction at temperatures below the melting point of the solid materials.

“Oxygen storage material (OSM)” refers to a material able to take up oxygen from oxygen rich streams and able to release oxygen to oxygen deficient streams.

“Oxygen storage capacity (OSC)” refers to the ability of materials used as OSM in catalysts to store oxygen at lean and to release it at rich condition.

“Conversion” refers to the chemical alteration of at least one material into one or more other materials.

“Adsorption” refers to the adhesion of atoms, ions, or molecules from a gas, liquid, or dissolved solid to a surface.

“Desorption” refers to the process whereby atoms, ions, or molecules from a gas, liquid, or dissolved solid are released from or through a surface.

“Extrapolation” refers to creating a tangent line at the end of the known data and extending it beyond that limit, based on calculations to predict the value of a variable by projecting past experience of known data.

“O₂ delay time” refers to the time required to reach to 50% of the 0₂ concentration in feed signal.

“CO delay time” refers to the time required to reach to 50% of the CO concentration in feed signal.

“Time on-stream” refers to the actual time that a unit is operating in a process operation.

Description of the Drawings

The present disclosure describes Zero-PGM (ZPGM) catalyst material compositions with enhanced oxygen storage capacity for improved performance of three-way catalyst (TWC) systems. Further, the present disclosure describes hydrothermally aged (e.g., using fuel cut aging) ZPGM catalyst material compositions exhibiting significantly higher oxygen storage capacity (OSC) stability properties.

ZPGM Catalyst Configuration, Material Composition, and Preparation

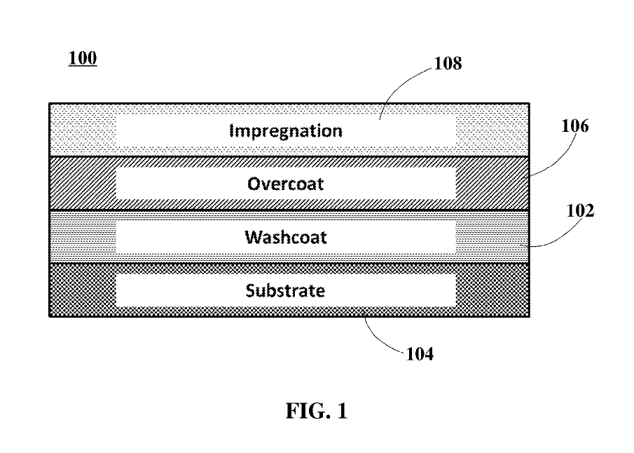

FIG. 1 is a graphical representation illustrating an improved three-way catalyst (TWC) system configuration including a washcoat (WC) layer coated overlying a suitable ceramic substrate, and overcoat (OC) layer overlying the WC layer, and an impregnation (IMP) layer impregnated onto the OC layer, according to an embodiment.

In FIG. 1, catalyst system configuration 100 includes WC layer 102, ceramic substrate 104, OC layer 106, and IMP layer 108. In some embodiments, WC layer 102 is coated onto ceramic substrate 104, OC layer 106 is coated onto WC layer 102, and IMP layer 108 is impregnated onto OC layer 106 by any suitable impregnation method. In an example, WC layer 102 is implemented as Alumina, OC layer 106 is implemented as a support oxide, and IMP layer 108 is implemented as a binary spinel structure.

Examples of materials suitable for use as OC layer 106 include support oxides, such as, MgAl₂O₄, Al₂O₃—BaO, Al₂O₃—La₂O₃, ZrO₂—CeO₂—Nd₂O₃—Y₂O₃, CeO₂—ZrO₂, CeO₂, SiO₂, Alumina silicate, ZrO₂—Y₂O₃—SiO₂, Al₂O₃—CeO₂, Al₂O₃—SrO, TiO₂-10% ZrO₂, TiO₂-10% Nb₂O₅, SnO₂—TiO₂, ZrO₂—SnO₂—TiO₂, BaZrO₃, BaTiO₃, BaCeO₃, ZrO₂—Pr₆O₁₁, ZrO₂—Y₂O₃, ZrO₂—Nb₂O₅, Al—Zr—Nb, and Al—Zr—La, amongst others. In an example, OC layer 106 is implemented as a doped Zirconia (ZrO₂-10% Pr₆O₁₁) support oxide.

In some embodiments, IMP layer 108 is produced using a plurality of binary spinel structures. In these embodiments, the binary spinel structures include aluminum, magnesium, manganese, gallium, nickel, copper, silver, cobalt, iron, chromium, titanium, tin, or mixtures thereof. In an example, IMP layer 108 is implemented as a binary spinel structure of copper (Cu) and manganese (Mn). In this example, the Cu-Mn spinel structure is produced using a general formulation CuₓMn₃₋ₓO₄ spinel, in which X preferably takes a value of about 1.0.

According to some embodiments, the preparation of ZPGM catalyst composition samples begins with the milling of alumina to produce a slurry. In these embodiments, the slurry of alumina is coated onto ceramic substrate 104 employing an alumina loading of about 120 g/L to form WC layer 102. In these embodiments, WC layer 102 is then fired at about 550° C. for about 4 hours. Further to these embodiments, OC layer 106 is separately produced by milling doped Zirconia support oxide with water to produce a slurry of doped Zirconia for coating onto WC layer 102 with a loading of about 120 g/L. In these embodiments, OC layer 106 is then fired at about 550° C. for about 4 hours.

In some embodiments, impregnation layer 108 is produced by mixing appropriate amounts of Cu nitrate and Mn nitrate solutions. In an example, the Cu nitrate solution used is about 23.6 wt % and the Mn nitrate solution used is about 40.8 wt %. In these embodiments, the Cu and Mn solutions are mixed for about 1 to 2 hours. Further to these embodiments, the mixture of Cu—Mn is then impregnated onto OC layer 106 using any suitable impregnation method. In some embodiments, the catalyst system configuration 100 is fired at a temperature within a range of about 550° C. to about 650° C., preferably at about 600° C. for about 5 hours.

In some embodiments, the ZPGM catalyst material compositions are aged using, for example, a fuel cut aging method at a temperature of about 800° C. for about 20 hours using a fuel gas. Examples of the components within the fuel gas include CO, O₂, CO₂, H₂O and N₂ used as an aging fuel feed, which runs at rich and lean modes.

Standard Isothermal Oscillating OSC Test Procedure

In some embodiments, the standard isothermal oscillating OSC test is performed on catalyst samples at a temperature of about 575° C. with a feed of either O₂ with a concentration of about 4,000 ppm diluted in inert nitrogen (N₂) simulating a lean cycle, or CO with a concentration of about 8,000 ppm of CO diluted in inert N₂ simulating a rich cycle. In these embodiments, the isothermal oscillating OSC test is performed within a quartz reactor using a space velocity (SV) of 60,000 hr⁻¹, ramping from room temperature to a temperature of about 575° C. under a dry N₂ environment. Further to these embodiments, when the temperature of about 575° C. is reached, the isothermal oscillating OSC test is initiated by flowing O₂ through the catalyst samples within the reactor. After about 240 seconds, the feed flow is switched to CO allowing CO to flow through the catalyst samples within the reactor for another 240 seconds. In some embodiments, OSC testing enables isothermal oscillating conditions, between CO and O₂ flows, during the different times on stream. In these embodiments, O₂ and CO are allowed to flow within an empty test reactor (before or after the OSC test) in order to establish test reactor benchmarks.

In some embodiments, the OSC stability properties of fresh and aged ZPGM catalyst material compositions are determined by using CO and O₂ pulses under standard isothermal oscillating conditions. In these embodiments, the OSC test facilitates the determination of O₂ and CO delay times for an extended number of rich and lean cycles to verify the OSC stability of the disclosed ZPGM catalyst material compositions. Further to these embodiments, the O₂ and and CO delay times are the times required to reach 50% of the O₂ and CO concentrations within the feed signal, respectively. The O₂ and CO delay times are used as parameters for the determination of the oxygen storage capacity of the ZPGM catalyst composition samples.

OSC Stability Properties of Fresh ZPGM Catalyst Composition Samples

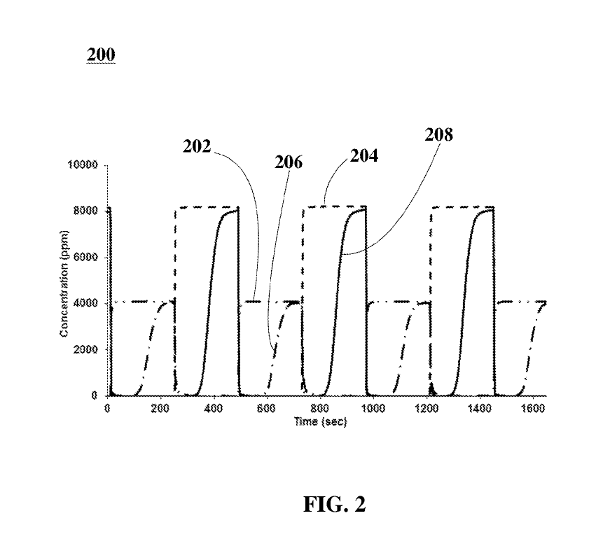

FIG. 2 is a graphical representation illustrating standard isothermal oscillating OSC test results of O₂ and CO delay times at about 575° C., according to an embodiment. In FIG. 2, OSC test results 200 includes O₂ benchmark 202, CO benchmark 204, O₂ curve 206, and CO curve 208.

In some embodiments, O₂ benchmark 202 (double-dot dashed graph) illustrates the results of flowing 4,000 ppm O₂ through an empty test reactor, CO benchmark 204 (dashed graph) illustrates the result of flowing 8,000 ppm CO through the empty test reactor, O₂ curve 206 (single-dot dashed graph) illustrates the result of flowing 4,000 ppm O₂ through the test reactor including the disclosed ZPGM catalyst composition, and CO curve 208 (solid line graph) illustrates the result of flowing 8,000 ppm CO through the test reactor including the disclosed ZPGM catalyst composition.

In these embodiments, the O₂ signal of the disclosed ZPGM catalyst composition does not reach the O₂ signal of the empty operating test reactor, as illustrated by O₂ curve 206 and O₂ benchmark 202 respectively. These OSC test results indicate the storage of a significant amount of O₂ within the disclosed ZPGM catalyst composition. Further to these embodiments, the measured O₂ delay time is about 136.2 seconds. In these embodiments, the O₂ delay time measured indicates the disclosed ZPGM catalyst composition exhibits significantly high OSC stability properties.

In other embodiments, the CO signal of the the disclosed ZPGM catalyst composition does not reach the CO signal of the empty operating test reactor, as illustrated by CO curve 208 and CO benchmark 204, respectively. These OSC results indicate the consumption of a significant amount of CO within the disclosed ZPGM catalyst composition due to oxidation reaction of CO with the stored O₂ to produce CO₂.

Further to these embodiments, the measured CO delay time is about 127.7 seconds. In these embodiments, the CO delay time measured illustrates the disclosed ZPGM catalyst composition material exhibits significantly high OSC stability properties.

In some embodiments, the measured O₂ and CO delay times indicate the disclosed ZPGM catalyst compositions exhibit enhanced OSC stability properties. In these embodiments, the enhanced OSC stability properties are illustrated by the highly activated reversible O₂ adsorption as well as the CO conversion that occurs under the isothermal oscillating conditions.

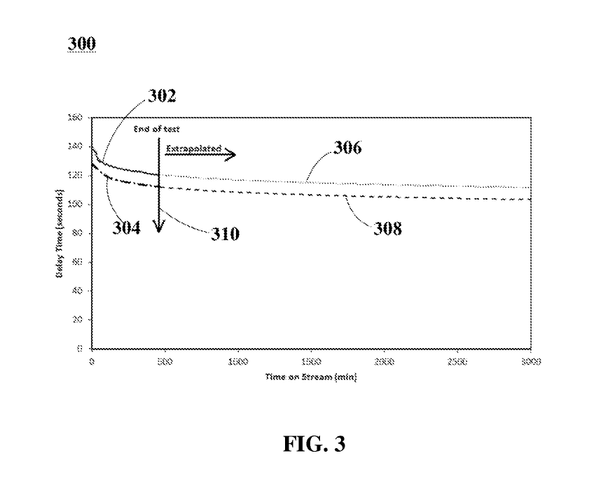

FIG. 3 is a graphical representation illustrating isothermal oscillating OSC stability test results of fresh ZPGM catalyst composition samples including test results of O2 and CO delay times at about 575° C., according to an embodiment. In FIG. 3, OSC stability test results 300 includes O₂ delay time curve 302, CO delay time curve 304, extrapolated O₂ delay time curve 306, extrapolated CO delay time curve 308, and end of test mark 310.

In some embodiments, the O₂ delay time is illustrated as O₂ delay time curve 302 (solid line graph) extended with dotted points for extrapolated values of time on stream as illustrated by extrapolated O₂ delay time curve 306. In these embodiments, the CO delay time is illustrated as CO delay time curve 304 (dot-solid line graph) extended with dashed lines for extrapolated values of time on stream as illustrated by extrapolated CO delay time curve 308. Further to these embodiments, the extrapolated O₂ and CO delay time values occur the after the end of the OSC stability test as illustrated by end of test mark 310. In these embodiments, there is not a significant decrease in O₂ and CO delay time over time. Therefore, the O₂ and CO delay time results indicate a significantly high OSC activity.

In some embodiments, the O₂ delay time at the beginning of the oscillating OSC test cycle exhibits a delay time value of approximately 137 seconds. In these embodiments, the O₂ delay after about 112 rich-lean cycles (at approximately 450 minutes of time on stream) indicates a value of about 121 seconds. Further to these embodiments, O₂ delay time curve 302 can be used to calculate the amount of OSC at future point in time by extrapolation calculations to predict the trend-line of OSC stability behavior of O₂ delay time curve 302 through about 3000 minutes of time on stream (approximately 750 cycles). In these embodiments, the extrapolated time delay curve is illustrated by extrapolated O₂ delay time curve 306. Further to these embodiments, the prediction of O₂ delay time for disclosed ZPGM catalyst compositions after approximately 750 rich-lean cycles is about 111 seconds.

In some embodiments, the CO delay time at the beginning of the oscillating OSC test cycle exhibits a delay time value of approximately 129 seconds. In these embodiments, the CO delay after 112 rich-lean cycles (at approximately 450 minutes of time on stream) indicates a value of about 112 seconds. Further to these embodiments, CO delay time curve 304 can be used to calculate the amount of OSC at future point in time by extrapolation calculations to predict the trend-line of OSC stability behavior of CO delay time curve 304 through about 3000 minutes of time on stream (approximately 750 cycles). In these embodiments, the extrapolated time delay curve is illustrated by extrapolated CO delay time curve 308. Further to these embodiments, the prediction of CO delay time for disclosed ZPGM catalyst compositions after approximately 750 rich-lean cycles is about 104 seconds.

In some embodiments, the oscillating OSC test results from about 112 rich-lean cycles, as illustrated by end of test mark 310, are used to extrapolate values and predict a trend-line to approximately 750 rich-lean cycles. The extrapolated values and associated predicted trend-line provide an indication the O₂ and CO delay times that do not reduce significantly, and remain with a high percentage of OSC, thereby demonstrating the OSC stability of fresh ZPGM catalyst compositions.

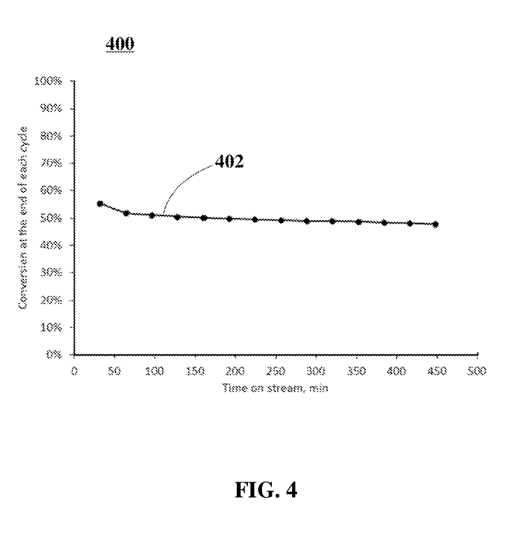

FIG. 4 is a graphical representation illustrating isothermal oscillating OSC test results of CO conversion stability on fresh ZPGM catalyst composition samples, at about 575° C., according to an embodiment. In FIG. 4, oscillating OSC test 400 includes CO conversion curve 402.

In some embodiments, within oscillating OSC test 400 the CO conversion occurs due to the consumption of stored O₂ from the OSC material during the lean cycles of oscillating OSC test 400. In these embodiments, CO conversion curve 402 illustrates conversion of CO over time on stream. Further to these embodiments, the oscillating OSC test results indicate that fresh ZPGM catalyst compositions exhibit a CO conversion of about 55% at the beginning of the cycle. In these embodiments, the oscillating OSC test results indicate a substantially similar steady rate of CO conversion for about 7.5 hours through approximately 112 rich-lean cycles. Further to these embodiments, the CO conversion decreases over the 112 rich-lean cycles from about 57% to about 48% conversion, as illustrated in CO conversion curve 402.

In some embodiments, test results of fresh ZPGM catalyst compositions indicated a high level of OSC stability properties during extended rich-lean cycles.

OSC Stability of Aged OSM Sample

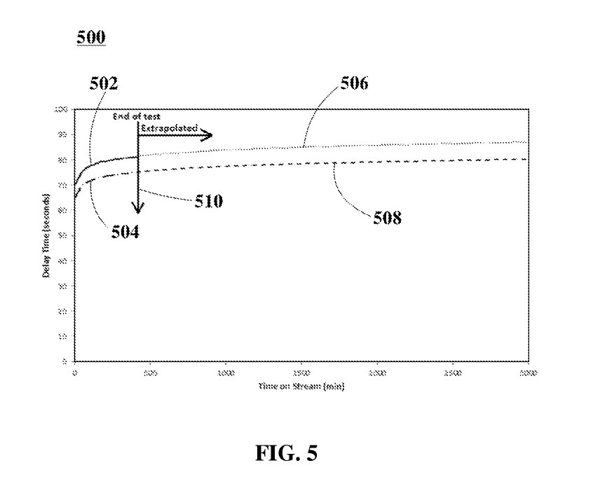

FIG. 5 is a graphical representation illustrating isothermal oscillating OSC test results of OSC stability of aged ZPGM catalyst composition samples, at about 575° C., according to an embodiment. In FIG. 5, OSC stability test results 500 includes O₂ delay time curve 502, CO delay time curve 504, extrapolated O₂ delay time curve 506, extrapolated CO delay time curve 508, and end of test mark 510.

In some embodiments, the O₂ delay time is illustrated as O₂ delay time curve 502 (solid line graph) extended with dotted points for extrapolated values of time on stream as illustrated by extrapolated O₂ delay time curve 506. In these embodiments, the CO delay time is illustrated as CO delay time curve 504 (dot-solid line graph) extended with dashed lines for extrapolated values of time on stream as illustrated by extrapolated CO delay time curve 508. Further to these embodiments, the extrapolated O₂ and CO delay times occur after the end of the OSC stability test as illustrated by end of test mark 510. In these embodiments, there is no significant O₂ and CO delay times decrease over time. Therefore, the O₂ and CO delay time results indicate a significantly high OSC activity.

In some embodiments, the O₂ delay time at the beginning of the oscillating OSC test cycle exhibits a delay time value of approximately 71 seconds. In these embodiments, the O₂ delay after about 112 rich-lean cycles (at approximately 450 minutes of time on stream) indicates a value of about 81 seconds. Further to these embodiments, slight increases of O₂ and CO delay times occur over time.

In some embodiments, after aging the ZPGM catalyst compositions the measured O₂ and CO delay times exhibit significantly high OSC stability, giving an indication that the OSC stability properties of disclosed ZPGM catalyst compositions are thermally stable.

The improved OSC stability properties of the disclosed ZPGM material compositions can be used in a large number of TWC catalyst applications with substantially similar or improved performance when compared to conventional TWC catalyst systems. The significantly high OSC stability properties after fuel cut aging of ZPGM catalyst compositions allow for the treating of exhaust gases produced by internal combustion engines, where lean and rich fluctuations in operating conditions produce high variations of exhaust pollutants.
ZPGM material composition, which can be used as TWC alone or used as OSM, for a plurality of TWC applications.
ZPGM materials are prepared by coating process including impregnation of Cu-Mn spinel with general formula of CuₓMn₃₋ₓO₄ on variety of support oxide such as Zirconia.
Disclosed ZPGM catalyst composition exhibit significant OSC properties, which is significantly stable after fuel cut aging, makes catalyst manufactures independent of using conventional rare earth metal oxide OSM for TWC applications.

The measured O₂ delay time and CO delay times is an indication that the disclosed ZPGM catalyst material, exhibit enhanced OSC, (delay time above 136 seconds).

The results from multiple rich-lean cycles shows O₂ and CO delay time does not reduce significantly and still keeps high percentage of OSC, indicating the stability of O2 and CO delay time of disclosed fresh ZPGM catalyst is still above 100 seconds.

OSC of disclosed ZPGM catalyst is thermally stable, aging the ZPGM material (under rich-lean aging mode) does not damage the OSC of spinel composition and disclosed ZPGM catalyst still exhibit stable O₂ and CO delay time, indicating thermal stability of OSC of disclosed ZPGM composition.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method of manufacturing a catalyst system comprising:
coating a washcoat on a substrate followed by firing at a first firing temperature for a first firing period,
after the first firing period, coating an overcoat on the washcoat followed by firing at a second firing temperature for a second firing period,
mixing Cu nitrate and Mn nitrate solutions for a mixing period to form a Cu—Mn mixture,
after the second firing period, impregnating the Cu-Mn mixture onto the overcoat followed by firing at a third firing temperature for a third firing period to form an impregnation layer, wherein
the overcoat includes at least one support oxide selected from the group consisting of MgAl₂O₄, Al₂O₃—BaO, Al₂O₃—La₂O₃, ZrO₂—CeO₂—Nd₂O₃—Y₂O₃, CeO₂—ZrO₂, CeO₂, SiO₂, Alumina silicate, ZrO₂—Y₂O₃—SiO₂, Al₂O₃—CeO₂, Al₂O₃—SrO, TiO₂-ZrO₂, TiO₂—Nb₂O₅, SnO₂—TiO₂, ZrO₂—SnO₂—TiO₂, BaZrO₃, BaTiO₃, BaCeO₃, ZrO₂—Pr₆O₁₁, ZrO₂—Y₂O₃, ZrO₂—Nb₂O₅, Al—Zr—Nb, and Al—Zr—La, and wherein
the impregnation layer includes CuₓMn₃₋ₓO₄ spinel.

2. The method of claim 1, wherein the at least one support oxide includes TiO₂-10% ZrO₂.

3. The method of claim 1, wherein the at least one support oxide includes TiO₂-10% Nb₂O₅.

4. The method of claim 1, wherein the at least one support oxide includes ZrO₂-10% Pr₆O₁₁.

5. The method of claim 1, wherein x is about 1.

6. The method of claim 1, wherein the Cu—Mn mixture comprises about 24% by weight Cu nitrate.

7. The method of claim 1, wherein the Cu—Mn mixture comprises about 23.6% by weight Cu nitrate.

8. The method of claim 1, wherein the Cu—Mn mixture comprises about 40% by weight Mn nitrate.

9. The method of claim 1, wherein the Cu—Mn mixture comprises about 41% by weight Mn nitrate.

10. The method of claim 1, wherein the Cu—Mn mixture comprises about 40.8% by weight Mn nitrate.

11. The method of claim 1, further comprising wherein the Cu—Mn mixture comprises about 40.8% by weight Mn nitrate.

12. The method of claim 1, wherein the third firing temperature is about 550° C. to about 650° C.

13. The method of claim 12, wherein the third firing temperature is about 600° C.

13. The method of claim 12, wherein the third firing temperature is about 600° C.

14. The method of claim 12, wherein the third firing period is about 5 hours.

15. The method of claim 1, wherein the first firing temperature and the second firing temperature is about 550° C.

16. The method of claim 1, wherein the first firing period and the second firing period is about 4 hours.

17. The method of claim 1, wherein the O₂ delay time is greater than 100 seconds.

18. The method of claim 1, wherein the O₂ delay time is greater than 130 seconds.

19. The method of claim 1, wherein the CO delay time is greater than 100 seconds.

20. The method of claim 4, wherein the Cu—Mn mixture comprises about 24% by weight Cu nitrate.
